(19) United States
(12) Patent Application Publication
(10) Pub. No.: US 2005/0141670 A1
(43) Pub. Date: Jun. 30, 2005

(54) X-ray generating device

(76) Inventors: Kozo Ichikawa, Yokohama-shi (JP); Seiji Kashiwa, Yokohama-shi (JP)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/898,267

(22) Filed: Jul. 26, 2004

(30) Foreign Application Priority Data
Dec. 25, 2003 (JP) 2003-428780

(51) Int. Cl. H05G 1/52; H01J 35/14

(52) U.S. Cl. 378/138

(57) ABSTRACT

An X-ray generating device comprises a focal electrode (10) placed adjacent to the cathode (9) and provided with a focal aperture (10a) aligning with the cathode. A positive voltage is applied to the focal electrode relative to the cathode so that equipotential lines around the focal aperture may bulge toward the X-ray target (2). Thereby, the part of the electron beam having a large diverging angle is captured by the focal electrode, and only the part of the electron beam having a uniform diverging angle is allowed to pass through the focal aperture so that the electron beam can be favorably micro focused upon the X-ray target and can be given with a high intensity.

### TECHNICAL FIELD

The present invention relates to an X-ray generating device typically in the form of an X-ray tube for use in medical, industrial and scientific applications, and in particular to an X-ray generating device in which a micro focused electron beam is converged upon an X-ray target. The present invention is highly suitable, not exclusively, for medical imaging purposes and non-destructive testing of semiconductor devices.

### BACKGROUND OF THE INVENTION

Known X-ray generating devices of this type include those using a focusing electrode or focusing magnetic pole for converging an electron beam as disclosed in Japanese patent publication No. 2002-358919, and those using a cathode assembly including a filament mounting disk for adjustably mounting a flat ribbon filament or a round wire filament so that the filament extends through an aperture in a focal plane disk, and a uniform focusing field may be achieved as disclosed in U.S. Pat. No. 5,077,777.

FIGS. 4a and 4b show the cathode assemblies of the X-ray tubes disclosed in U.S. Pat. No. 5,077,777, along with the electric field that is produced in the vicinity of each cathode assembly. The cathode 11 consists of a flat ribbon filament or a round wire filament, and a tip of the cathode 11 projects out of a focusing aperture of the focal plane disk 12 toward the anode (X-ray target).

In the case of the example illustrated in FIG. 4a, the cathode 11 and focal plane disk 12 are at a same voltage (or 0 V). A high voltage of 60 kV is applied to the X-ray target. An electron beam x is emitted from the cathode 11 by conducting electric current through the cathode 11 and heating the same. Because the focal plane disk 12 is at the same voltage as the cathode 11, the electron beam x emitted from the projecting tip of the cathode 11 is radiated over wide ranges of angle and initial velocity. The equipotential lines y are therefore somewhat disturbed so that it is difficult to converge the radiated electron beam onto a single point on the X-ray target or to achieve a micro focusing.

In the case of the example illustrated in FIG. 4b, the focal plane disk 12 is at a negative voltage while the cathode 11 is at 0 V. In this case also, a high voltage of 60 kV is applied to the X-ray target. The equipotential lines y formed around the cathode 11 which is at 0 V consist of postive equipotential lines y1 and negative equipotential lines y2. The radiation of the electron beam that is emitted from the tip of the cathode 11 is limited to the region of the postive equipotential lines y1 and the cross sectional area of the electron beam is substantially smaller than that shown in FIG. 4a. Therefore, by suitably selecting the shape of the focal plane disk 12, a desired micro focusing may be achieved.

However, these prior proposals have some problems that are desired to be eliminated. In the first instance, a desired micro focusing may be achieved, but a highly complex and unacceptably large focusing electrode or magnetic pole is required. Therefore, the electrode arrangement around the cathode may take up too large a space for some applications, and is unacceptably expensive to manufacture. In the second instance, an electron beam of a desired intensity may not be obtained, and it means an X-ray beam of a desired intensity may not be obtained. Also, a slightly spreading of electrons around the point of micro focusing is inevitable, and it means a lack of contrast in the produced X-ray beam.

### BRIEF SUMMARY OF THE INVENTION

In view of such problems of the prior art, a primary object of the present invention is to provide an X-ray generating device which is free from such problems of the prior art.

A second object of the present invention is to provide an X-ray generating device which is capable of producing a properly micro focused electron beam of a desired intensity.

A third object of the present invention is to provide an X-ray generating device which is relatively economical to manufacture and compact in size.

According to the present invention, at least most of such objects can be accomplished by providing an X-ray generating device, comprising: a cathode provided with a surface for emitting an electron beam; a focal electrode placed adjacent to the cathode and provided with a focal aperture aligning with the cathode; and an X-ray target placed coaxially with respect to the cathode on a side of the focal electrode facing away from the cathode and adapted to have the electron beam emitted from the cathode impinge upon the X-ray target, a high positive voltage being applied to the X-ray target relative to the cathode; and an evacuated envelope accommodating the cathode, focal electrode and X-ray target; a positive voltage being applied to the focal electrode relative to the cathode so that equipotential lines around the focal aperture may bulge toward the X-ray target. Preferably, the cathode is provided with a planar and circular surface for emitting an electron beam.

Thereby, the electron beam is uniformly emitted from the preferably planar and circular surface so that the electron beam can be emitted uniformly from a large surface area, and the traveling distance of the electron beam from the cathode to the X-ray target highly uniform. In particular, because a positive voltage of a suitable level is applied to the focal electrode, the part of the electron beam having a large diverging angle is captured by the focal electrode, and only the part of the electron beam having a uniform diverging angle is allowed to pass through the focal aperture. This is achieved particularly favorably when the equipotential lines around the focal aperture bulge toward the X-ray target. Thereby, the electron beam can be favorably micro focused upon the X-ray target and can be given with a high intensity.

More specifically, the focal electrode having a positive voltage applied thereto provides the function of drawing electrons from the cathode and the function of removing the components of the electron beam that prevent a micro focusing. Therefore, only the part of the electron beam having a uniform divergent angle and free from mutually crossing components is allowed to travel to the X-ray target. The focal electrode can be therefore considered as providing the function of a grid electrode at the same time for preventing the disturbances in the electron beam and a drop in the intensity of the electron beam.

Preferably, a positive voltage of 0.2% to 0.7% of the voltage applied to the X-ray target is applied to the focal electrode. When this voltage is lower, an electron beam having a uniform divergent angle cannot be obtained. When the voltage is higher, a large part of the emitted electron beam is captured by the focal electrode so that not only a micro focusing cannot be achieved but also the intensity of the electron beam significantly diminishes.

Preferably, the focal electrode is provided with a focal aperture disposed coaxially with respect to the cathode and X-ray target. The effective surface area of the cathode that emits the electron beam and the diameter of the focal aperture are critical factors that determine the intensity of the electron beam that is desired to be micro focused on the X-ray target. By increasing the sizes of the cathode and focal aperture, the intensity of the emitted electron beam can be increased. However, the component of the electron beam having a large divergent angle can be removed only when the focal aperture is smaller than the effective diameter of the cathode.

The present invention can thus provide an X-ray generating device which is free from the problems of the prior art, and capable of producing a properly micro focused electron beam of a desired intensity. Furthermore, the X-ray generating device according to the present invention can be manufactured economically and designed as a highly compact device.

### BRIEF DESCRIPTION OF THE DRAWINGS

Now the present invention is described in the following with reference to the appended drawings, in which:

FIG. 1 is a schematic sectional view of an X-ray generating device embodying the present invention;

FIGS. 2a to 2d are schematic views of various embodiments of the electrode arrangement around the cathode according to the present invention;

FIGS. 3a to 3f are schematic views of various embodiments of the planar cathode according to the present invention; and

FIGS. 4a and 4b are schematic views of conventional electrode arrangements around a cathode.

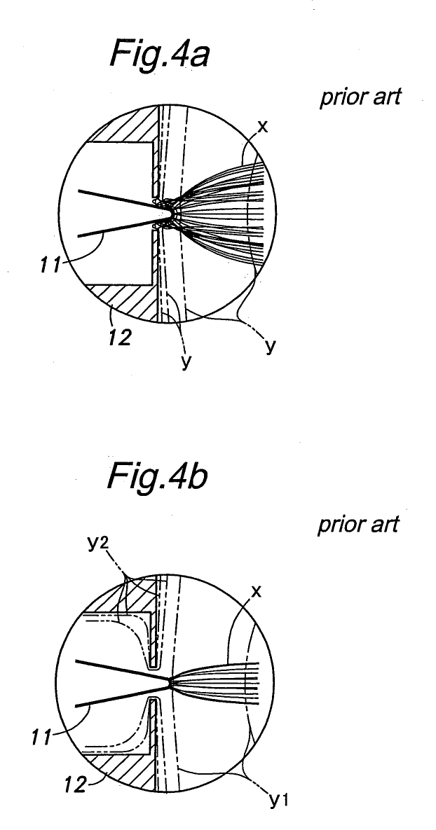

### DETAILED DESCRIPTION OF THE PREFERRED EMBODIMENTS

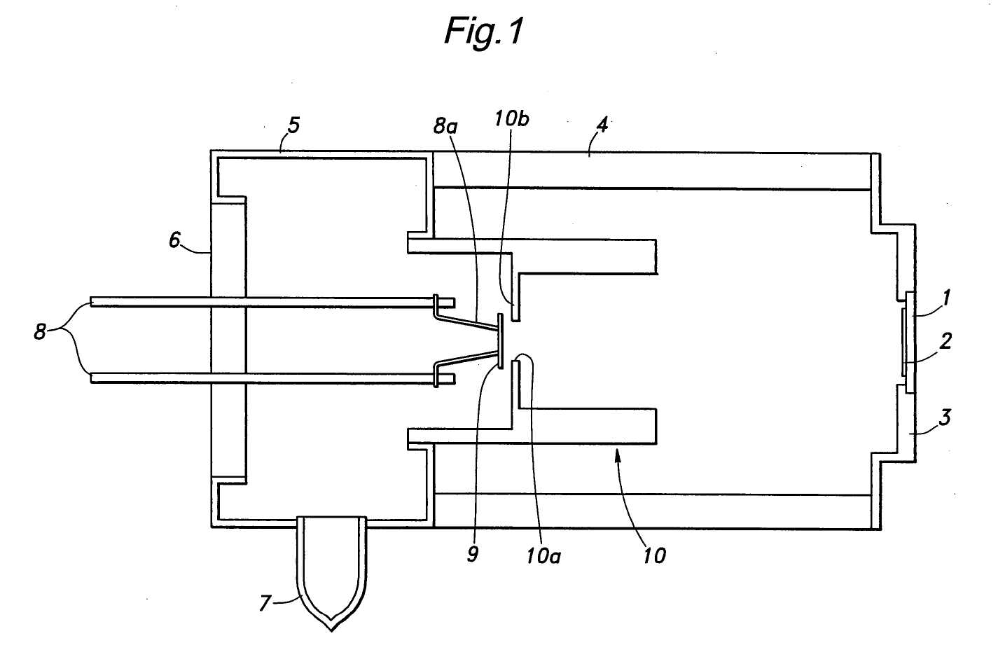

FIG. 1 shows a sectional view of an X-ray generating device embodying the present invention which comprise a housing defining an evacuated envelope. The anode end of the housing comprises a cylindrical section 4 and an end plate 3 both made of insulating material such as ceramics. The end plate 3 is provided with an X-ray window 1, an X-ray target 2 placed thereon and an electrode for applying a high voltage to the X-ray target 2. The X-ray target 2 forms the anode which emits X-ray radiation when impacted by an electron beam.

The cathode end of the housing similarly comprises a cylindrical section 5 and an end plate 6. The end plate 6 is provided with a pair of lead terminals 8 which are connected to an external heater power source (not shown in the drawings). A disk-shaped planar cathode 9 is attached to a filament 8a which is in turn connected to the lead terminals 8. The cylindrical section 5 is provided with an evacuation tube 7 which sealed by fusing after the interior of the housing is evacuated. The cylindrical section 5 supports a cylindrical focal electrode 10 which includes a focal plate 10b formed with a circular focal aperture 10a having a smaller diameter than the outer diameter of the planar cathode 9.

The planar cathode 9 is at 0 V and the X-ray target 2 is at a high voltage of 60 kV or even higher as is commonly is the case with the conventional arrangement. On the other hand, the focal electrode 10 is at a positive voltage with respect to the planar cathode 9. Therefore, the electron beam emitted from the planar cathode 9 is made to converge into a narrow beam by the action of an electric field lens formed by the voltages applied to the planar cathode 9, focal electrode 10 and X-ray target 2, and is micro focused upon the X-ray target 2.

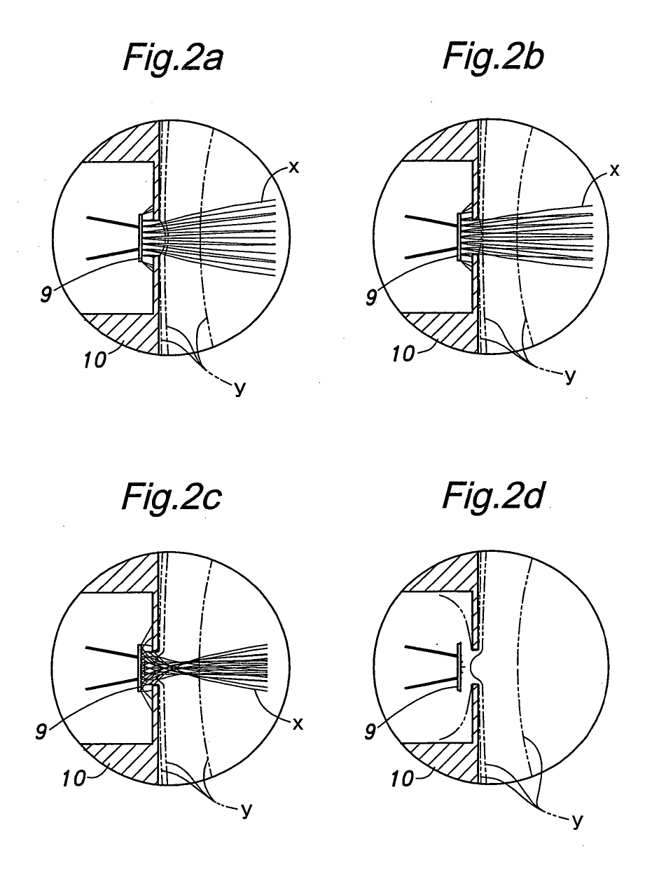

In the case of the embodiment illustrated in FIG. 2a, a voltage of +250 V is applied to the focal electrode 10. Because the equipotential lines bulge out toward the X-ray target 2 or present a concvex shape toward the X-ray target 2, the part of the electron beam having a relatively divergent angle is captured by the focal electrode having a positive voltage level, and only the part of the electron beam having a relatively narrow radiation angle is allowed to pass through the focal aperture 10a. As a result, a micro focusing of the electron beam onto the X-ray target can be achieved in a relatively simple manner.

In the case of the embodiment illustrated in FIG. 2b, a voltage of +100 V is applied to the focal electrode 10. Similarly as the embodiment illustrated in FIG. 2a, because the equipotential lines still bulge out toward the X-ray target 2, the part of the electron beam having a relatively divergent angle is captured by the focal electrode having a positive voltage level so that the electron beam can be favorably made to converge upon the X-ray target 2. However, the positive voltage applied to the focal electrode 10 is relatively low, the uniformity in the radiation angle of the electron beam x is somewhat lost, and an optimum micro focusing on the X-ray target 2 may not be obtained.

In the case of the embodiment illustrated in FIG. 2c, 0V is applied to the focal electrode 10 or the focal electrode is at the same voltage as the planar cathode 9. Because the equipotential lines bulge inward toward the planar cathode 9 or present a concave shape toward the X-ray target 2, it is not possible to properly focus or converge the electron beam x upon the X-ray target 2.

In the case of the embodiment illustrated in FIG. 2d, a voltage of −10 V is applied to the focal electrode 10. Because the positive electric field does not reach the region adjacent to the planar cathode 9, the emitted electron beam x is forced back to the planar cathode 9, and is unable to travel to the X-ray target 2.

Thus, a desired micro focusing can be achieved by applying a positive voltage of an appropriate level to the focal electrode 10 with respect to the planar cathode 9 which is at 0 V. At the same time, it is necessary to select the areas of the planar cathode 9 and focal aperture 10a of the focal electrode 10, distance between the planar cathode 9 and focal aperture 10a of the focal electrode 10, and distance between the planar cathode 9 and X-ray target 2 without regard to the voltage applied to the focal electrode 10 in order to achieve a required intensity of the electron beam x that is impinged upon the X-ray target 2.

For instance, the spacing between the planar cathode 9 and focal aperture 10a of the focal electrode 10 may be 50 to 500 μm, and the planar cathode 9 may have a slightly larger area than the focal aperture 10a. The voltage of the focal electrode 10 is preferably in the order of 0.2 to 0.7% of the voltage of the anode or the X-ray target 2 (120 to 420 V when the voltage of the X-ray target 2 is 60 kV). At any event, it is necessary that the equipotential lines at the focal aperture 10a bulge out toward the X-ray target 2 by applying a suitable positive voltage to the focal electrode 10.

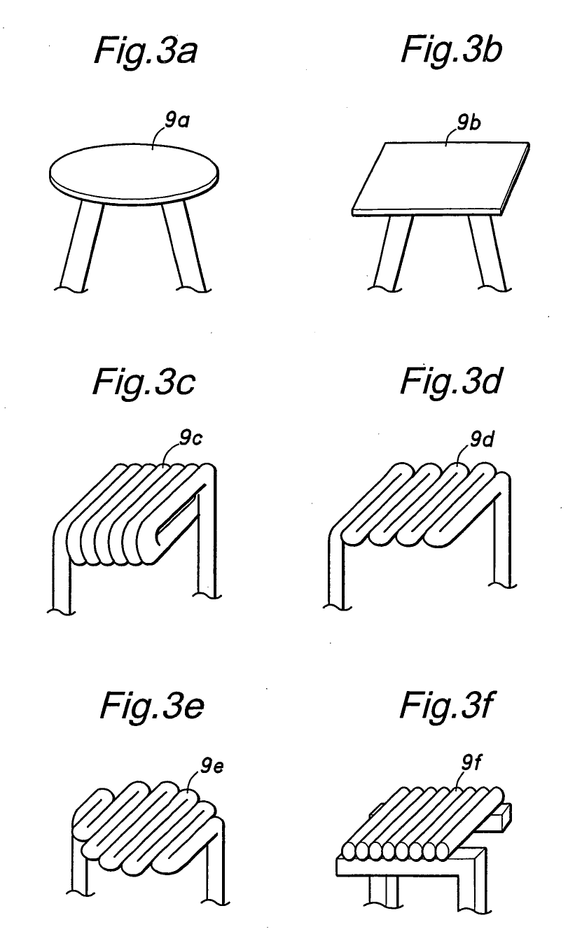

To the end of keeping the traveling distance of the electron beam x from the cathode 9 to the X-ray target 2 uniform and allowing the electron beam to be radiated from a large area while conforming to the focal aperture 10a, it is desirable for the planar cathode 9a to be circular and disk shaped as illustrated in FIG. 3a. The focal aperture 10a should be arranged coaxially with respect to the planar cathode 9. It is however possible to form the cathode 9b as a rectangular or square plate as illustrated in FIG. 3b.

It is also possible to form the cathode 9c by winding a wire into a flattened coil and using the broad rectangular side surface as the surface for emitting the electron beam as illustrated in FIG. 3c. Alternatively, the cathode 9c may be formed by bending a wire into a meandering shape and using the flat and broad surface thereof having a rectangular shape as the surface for emitting the electron beam as illustrated in FIG. 3d. The flat broad surface of the cathode 9e may also be shaped into a circular shape as illustrated in FIG. 3e.

According to yet another embodiment of the planar cathode 9f, a plurality of wires may be placed between a pair of electrodes in a mutually parallel and closely placed relationship as illustrated in FIG. 3f. The adjoining wires may be welded to or fused to each other. When the cathode is made of wire, the wire may consist of the electroresistive filament so that the filament also serves as the cathode.

In the conventional arrangement, a negative voltage is typically applied to the focal electrode or grid for the purpose of controlling the electric current of the X-ray target. In the present invention, a certain positive voltage is applied to the focal electrode 10 for similar purposes. Because the voltage between the cathode and focal electrode is relative, it is also possible to apply a negative voltage to the cathode or otherwise control the voltage of the cathode relative to that of the focal electrode.

Although the present invention has been described in terms of preferred embodiments thereof, it is obvious to a person skilled in the art that various alterations and modifications are possible without departing from the scope of the present invention which is set forth in the appended claims.

1. An X-ray generating device, comprising:
a cathode provided with a surface for emitting an electron beam;
a focal electrode placed adjacent to the cathode and provided with a focal aperture aligning with the cathode; and
an X-ray target placed coaxially with respect to the cathode on a side of the focal electrode facing away from the cathode and adapted to have the electron beam emitted from the cathode impinge upon the X-ray target, a high positive voltage being applied to the X-ray target relative to the cathode; and
an evacuated envelope accommodating the cathode, focal electrode and X-ray target;
a positive voltage being applied to the focal electrode relative to the cathode so that equipotential lines around the focal aperture may bulge toward the X-ray target.

2. An X-ray generating device according to claim 1, wherein the cathode consists of a planar cathode provided with a planar surface for emitting an electron beam.

3. An X-ray generating device according to claim 2, wherein the planar cathode is provided with a circular shape.

4. An X-ray generating device according to claim 2, wherein the planar cathode is provided with a rectangular shape.

5. An X-ray generating device according to claim 2, wherein the planar cathode is formed from a plate member.

6. An X-ray generating device according to claim 2, wherein the planar cathode is formed by bending or coiling a wire.

7. An X-ray generating device according to claim 1, wherein a positive voltage of 0.2% to 0.7% of the voltage applied to the X-ray target is applied to the focal electrode.

8. An X-ray generating device according to claim 1, wherein the focal aperture is disposed coaxially with respect to the cathode and X-ray target.

9. An X-ray generating device according to claim 8, wherein the focal aperture is provided with a circular shape, and the cathode is provided with a circular shape and disposed coaxially with respect to the focal aperture, the focal aperture having a slightly smaller diameter than the cathode.
